(19) United States
(12) Patent Application Publication
(10) Pub. No.: US 2014/0082307 A1
(43) Pub. Date: Mar. 20, 2014

(54) SYSTEM AND METHOD TO ARBITRATE ACCESS TO MEMORY

(71) Applicant: MOBILEYE TECHNOLOGIES LIMITED, Nicosia (CY)

(72) Inventors: Yosef Kreinin, Jerusalem (IL); Yosi Arbeli, Rishon Le-Zion (IL)

(73) Assignee: MOBILEYE TECHNOLOGIES LIMITED, NICOSIA (CY)

(21) Appl. No.: 13/621,308

(22) Filed: Sep. 17, 2012

(51) Int. Cl. G06F 12/08

(52) U.S. Cl. 711/158; 711/E12.016

(57) ABSTRACT

Arbitrating memory access between a central processing unit CPU and a peripheral device to main memory. The memory access to and from the main memory by the CPU and memory access to and from the main memory by the peripheral device is prioritized respectively according to a CPU priority level and a peripheral device priority level. An arbitration module is provided externally to the CPU, to the peripheral device and to the memory controller. The arbitration module receives the peripheral device priority level. When the CPU priority level and the peripheral device priority level are both set at the highest available priority level, the arbitration module outputs to the memory controller a new CPU priority level less than the highest available priority level.

### BACKGROUND

1. Technical Field The present invention relates to computer architecture and specifically to prioritizing access to memory.

2. Brief Summary

Various systems are provided which include a central processing unit (CPU), a peripheral device connected to a memory controller configured to control a main memory. Access to and from the main memory by the CPU and access to and from the main memory by the peripheral device is prioritized respectively according to a CPU priority level and a peripheral device priority level. An arbitration module is operatively attached to: the CPU, the peripheral device and to the memory controller. The arbitration module is configured to receive the peripheral device priority level. When the CPU priority level and the peripheral device priority level are both set at the highest available priority level, the arbitration module is configured to output to the memory controller a new CPU priority level less than the highest available priority level.

The arbitration module may be configured to receive the CPU priority level. When the CPU priority level and the peripheral device priority level are set at different priority levels, the arbitration module is configured to output to the memory controller the new CPU priority level equal to the CPU priority level as received.

The CPU priority level may be a predetermined constant value equal to the highest available priority level. The CPU priority level may be set by the CPU or a device external to the CPU. The peripheral device priority level may be set by the peripheral device or may be set by a device external to the peripheral device.

The peripheral device may be a video controller adapted to write streaming image data into the main memory. The video controller may include a write buffer for temporary storage of the image data prior to writing the image data into the main memory. The video controller sets and outputs to the arbitration module the highest available priority level when the write buffer is substantially full. The video controller sets and outputs to the arbitration module a priority level less than the highest available priority level when the write buffer is less than substantially full. Accordingly, the priority level for the peripheral device may be set at a value proportional to the fullness of the write buffer

The peripheral device may a video controller adapted to read streaming image data from the main memory. The video controller may include a read buffer for temporary storage of the image data prior to outputting the image data read from the main memory. The video controller sets and outputs to the arbitration module the highest available priority level when the write buffer is substantially empty. The video controller sets and outputs to the arbitration module a priority level less than the highest available priority level when the write buffer is not substantially empty. Accordingly, the priority level for the peripheral device may be set at a value proportional to the emptiness of the read buffer

Various methods are provided for arbitrating memory access between a central processing unit CPU and a peripheral device to main memory.

The memory access to and from the main memory by the CPU and memory access to and from the main memory by the peripheral device is prioritized respectively according to a CPU priority level and a peripheral device priority level . An arbitration module is provided externally to the CPU, to the peripheral device and to the memory controller. The arbitration module receives the peripheral device priority level from the peripheral device. When the CPU priority level and the peripheral device priority level are both set at the highest available priority level, the arbitration module outputs to the memory controller a new CPU priority level less than the highest available priority level. The CPU priority level may be set by either said CPU or a device external to said CPU. The peripheral device priority level may be set by the peripheral device.

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 illustrates a system for arbitrating memory access between a central processing unit CPU and a peripheral device to main memory.

FIG. 2 illustrates another system for arbitrating memory access to a main memory, according to a feature of the present invention.

FIG. 3 illustrates yet another system for arbitrating memory access to main memory, according to a feature of the present invention.

FIG. 4 shows more details of an arbitration module, according to a feature of the present invention.

FIG. 5 which shows a method, according to a feature of the present invention.

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

By way of introduction, aspects of the present invention are directed to arbitrating memory access between a central processing unit CPU and a peripheral device to and from a main memory. According to aspects of the present invention, an arbitration module may be configured to output to the main memory controller a new and/or modified CPU priority level which is less than the highest available priority level so that data from the peripheral device is not lost.

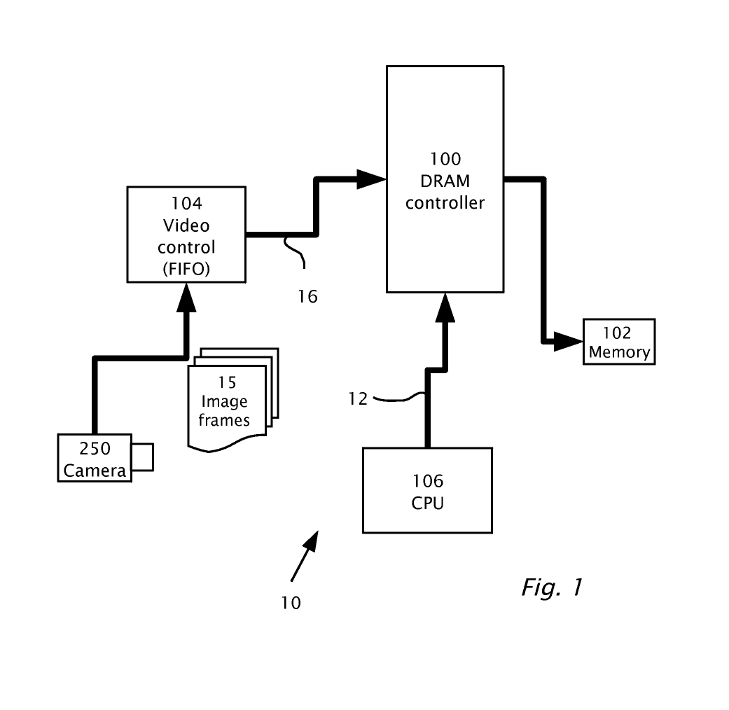

Reference is now made to FIG. 1 which illustrates a system 10 for arbitrating memory access between a central processing unit CPU 106 and a peripheral device, e.g. video controller 104 to main memory 102. Other examples of peripheral device 104 may include a gaming interface, video display and a sound interface card. In system 10, video control unit receives image frames 15 in real time from camera 250. Video control unit 104 may contain one or more temporary data storage buffers (labeled FIFO for first in first out). During a memory write operation data is transferred from FIFO data buffer and transferred to dynamic random access memory (DRAM) controller 100 on data line 16. DRAM controller 100 may receive data from central processing unit (CPU) 106 on data line 12.

Writing to memory 102 by video controller 104 or CPU 106 is prioritized by DRAM controller 100 based on priority levels supplied respectively to DRAM controller 100.

Some examples of peripheral devices 104 and/or CPU 106 may set their own priority level. Otherwise, the priority levels may be set externally to peripheral device 104, CPU 106 and DRAM controller 100. Priority levels for a DRAM controller 100 may be 2 bits, giving four possible priority levels (0-3) from either video controller 104 or CPU 106. Normally, CPU 106 is given the highest priority for memory access because while waiting for data, CPU 106 completely stops. Normally, video controller 104 does not require the highest priority because image frames 15 are temporarily stored in data buffer FIFO. However, when video controller 104 and CPU 106 have the same level of highest priority (3), a loss of an image frame 15 may occur if CPU 106 is still accessing memory 102 when write buffer FIFO overflows. Loss of an image frame 15 may be unacceptable for instance in camera based driver assistance systems and other real time, e.g. video, digital processing systems.

CPU 106, peripheral device 104 and DRAM controller 100 may be “off-the-shelf” components. Under normal circumstances it may be that neither CPU 106 nor peripheral device 104 are available with priority level generation logic, because arbitration with priority may not be included in standard bus protocols. CPU 106 is not configured to receive a signal from peripheral device 104 and or otherwise change CPU priority status for memory access based on immediate requirement of peripheral device 104.

Thus, there is a need for and it would be advantageous to have a system and method for preventing data loss in the event that peripheral device, e.g. video controller 104 does not receive timely access to memory 102.

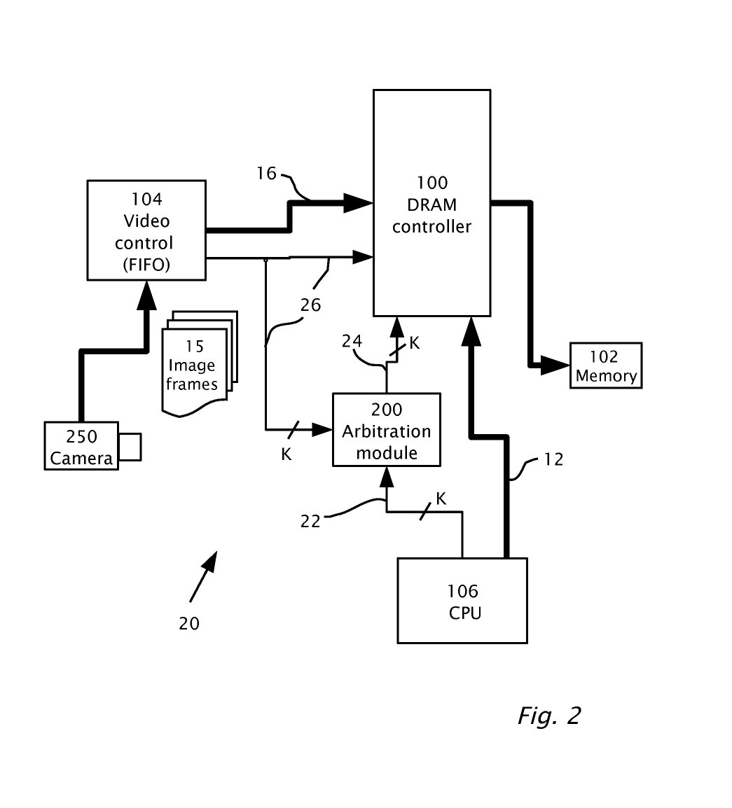

Reference is now made to FIG. 2 which illustrates a system 20 for arbitrating memory access to main memory 102, according to a feature of the present invention. System 20 is the same as system 10 but further includes an arbitration module 200. System 20 includes central processing unit CPU 106 and peripheral device, e.g. video controller 104 and main memory 102 connected as in system 10. In system 20, video control unit 104 FIFO buffer receives image frames 15 in real time from camera 250. During a memory write operation, data are transferred from the FIFO data buffer to dynamic random access memory (DRAM) controller 100 on data line 16. DRAM controller 100 receives data from central processing unit (CPU) 106 on data line 12. In system 20, data lines are shown as thick black lines and control lines are shown by thinner black lines

Arbitration module 200 is operatively attached to CPU 106 to receive priority control line 22 which is K bits wide. Priority control line 22 may alternatively receive a CPU priority level from another component (not shown) in system 20 other than CPU 106 or the CPU priority level on priority control line 22 may be set at a predetermined constant value without priority control line 22 as shown. Video controller 104 provides a priority control line 26 which is supplied to both DRAM controller 100 and arbitration module 200.

Video control unit 104 priority level may be set as a discrete variable priority level according to the remaining capacity of peripheral 104 FIFO buffer to store additional data. For video control unit 104 FIFO buffer being empty a priority level of 0 may be set. For video control unit 104 FIFO buffer somewhat full a priority level of 1 may be set, which may be equal to that of other co-processors or accelerators not shown in system 20. For a video control unit 104 FIFO buffer still fuller a priority level of 2 may be set which may be greater than that of the other co-processors but still below that of the priority level of CPU 106. When control unit 104 FIFO buffer is nearly full, a priority level may be set of 3 (for K=2 bits) equal to the CPU priority level. Accordingly, arbitration unit 200 may provide a modified or new priority level on priority control line 24 for CPU 106 which is based on the priority level of peripheral 104.

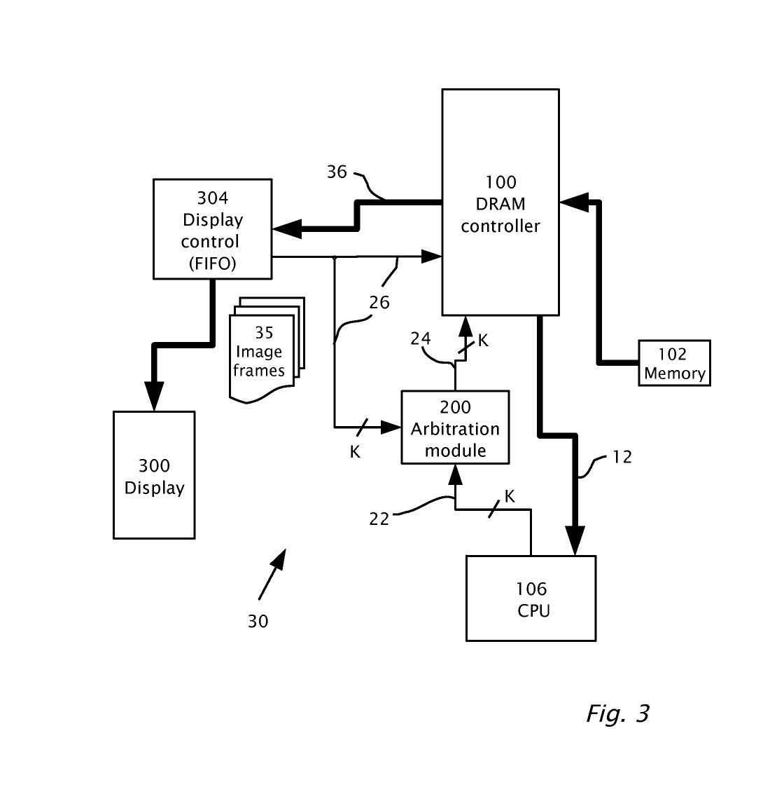

Reference is now also made to FIG. 3 which illustrates a system 30 for arbitrating memory access to main memory 102, according to a feature of the present invention. Display controller 304 reads data from memory 102 and provides image frames 35 to display 300. System 30 shows data flow along data lines including data lines 36 and 12 where data may be read from main memory 102 respectively by display controller 304 and CPU 106. Display controller 304 provides a priority control signal to DRAM controller 100 and to arbitration module 200 over control lines 26. A priority control signal to arbitration module 200 may be provided over control line 22 from CPU 106 as shown. Priority control line 22 may alternatively receive a priority level from another component in system 30 or the priority level on priority control line 22 may be set at a constant value at arbitration module 200 without the need for priority control line 22.

Arbitration unit 200 provides a modified priority output for CPU 106 on priority control line 24 which is based on the received priorities for reading data provided on priority control lines 22 and 26.

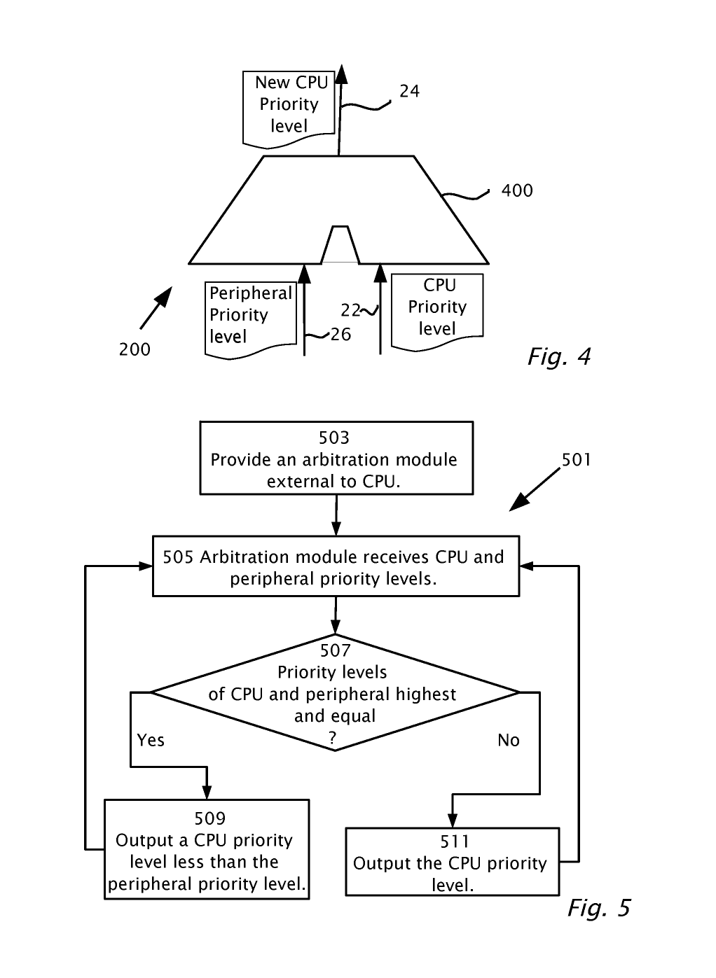

Reference is now made to FIG. 4 which shows more details of arbitration module 200, according to a feature of the present invention. Arbitration module 200 includes a logic module 400 which has two inputs from priority control lines 22 and 26. If K is two bits then four possible priority levels (0-3) are available from CPU 106 on priority control line 22 and from video control 104 on priority control line 26. In FIG. 4, if (as shown) both priority control lines 22 and 26 carry CPU 106 priority level and peripheral 104 priority level respectively. If for example, CPU 106 priority level and peripheral 104 priority level are both set at a maximum priority of 3, then the new CPU priority level carried on priority control line 24 is reduced to 2. Priority control line 24 modifies the priority level of CPU 106 to the new priority level of CPU 106 when both data lines have a maximum priority of 3, otherwise new priority level is the same value as the CPU priority level on priority control line 22.

Reference is now also made to FIG. 5 which shows a method 501, according to a feature of the present invention. In step 503, arbitration module 200 is provided externally to CPU 106 because priority of memory access of CPU 106 may not be configurable based on signaling from peripheral devices 104, 304.

In step 505, arbitration module 200 receives priority levels from CPU 106 and peripheral device 104, 304 for instance on priority control lines 22 and 26 respectively.

In decision block 507, if the priority levels of both CPU 106 and peripheral device 104, 304 are both at a maximum (priority level 3 for K=2 bits), i.e. both have priority levels of 3, then the modified output on priority control line 24 is reduced to 2 in step 509, so that CPU 106 priority level is less than the priority level (3) of video control 104. If in decision 507, the priority levels of both CPU 106 and peripheral device 104, 304 are not at a maximum (priority level 3 for K=2 bits) then the modified output on priority control line 24 is the same value as the priority value on priority control line 22 in step 511. After either step 509 or step 511, step 505 continues, with arbitration module 200 receiving priority levels from CPU 106 and video control 104 on priority control lines 22 and 26 respectively.

Video control 104 may set its priority for memory access dependent on how full is FIFO data buffer. The more full the ‘write’ FIFO data register in video control 104, the higher is the priority set by video control 104 on priority control line 26. In the case of reading from main memory 102 (as shown in system 30), display controller 304 priority level may be set depending on how empty a ‘read’ FIFO data register is in display controller 304. The more empty the ‘read’ FIFO data register is in display controller 304, the higher is the priority set by display controller 304 on priority control line 26.

The indefinite articles “a”, “an” is used herein, such as “a processor”, has the meaning of “one or more” that is “one or more processors”.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

What is claimed is:

1. A system comprising:
a central processing unit (CPU);
a peripheral device;
a memory controller configured to control a main memory, wherein the CPU and peripheral devices operatively connect to said memory controller;
wherein access to and from the main memory by the CPU and access to and from the main memory by the peripheral device is prioritized respectively according to a CPU priority level and a peripheral device priority level;
an arbitration module operatively attached to the CPU, the peripheral device and the memory controller, wherein the arbitration module is configured to receive the peripheral device priority level and when the CPU priority level and the peripheral device priority level are both set at the highest available priority level, the arbitration module is configured to output to the memory controller a new CPU priority level less than the highest available priority level.

2. The system of claim 1, wherein the arbitration module is configured to receive the CPU priority level and when the CPU priority level and the peripheral device priority level are set at different priority levels, the arbitration module is configured to output to the memory controller, the new CPU priority level equal to the CPU priority level as received

3. The system of claim 1, wherein the CPU priority level is a predetermined constant value equal to the highest available priority level.

4. The system of claim 1, wherein said CPU priority level is settable by either said CPU or a device external to said CPU.

5. The system of claim 1, wherein the arbitration module is configured to receive the CPU priority level.

6. The system of claim 1, wherein said peripheral device priority level is settable by either said peripheral device or a device external to the peripheral device.

7. The system of claim 1, wherein the peripheral device is a video controller adapted to write streaming image data into the main memory.

8. The system of claim 7, wherein the video controller includes a write buffer for temporary storage of the image data prior to writing the image data into the main memory, whereby the video controller sets and outputs to the arbitration module the highest available priority level when the write buffer is substantially full, whereby the video controller sets and outputs to the arbitration module a priority level less than the highest available priority level when the write buffer is less than substantially full.

9. The system of claim 1, wherein the video controller includes a write buffer for temporary storage of the image data prior to writing the image data into the main memory and wherein the priority level for the peripheral device may be set at a value proportional to the fullness of the write buffer.

10. The system of claim 1, wherein the peripheral device is a video controller adapted to read streaming image data from the main memory.

11. The system of claim 10, wherein the video controller includes a read buffer for temporary storage of the image data prior to outputting the image data read from the main memory, whereby the video controller sets and outputs to the arbitration module the highest available priority level when the read buffer is substantially empty, whereby the video controller sets and outputs to the arbitration module a priority level less than the highest available priority level when the read buffer is not substantially empty.

12. The system of claim 1, wherein the peripheral device includes a read buffer for temporary storage of the image data prior to outputting the image data read from the main memory and wherein the priority level for the peripheral device is set at a value proportional to the emptiness of the read buffer.

13. A method for arbitrating memory access between a central processing unit CPU and a peripheral device to main memory, wherein the memory access to and from the main memory by the CPU and to and from the main memory by the peripheral device is prioritized according to a CPU priority level and a peripheral device priority level, the method comprising:
providing an arbitration module external to the CPU, the peripheral device and the memory controller;
receiving by the arbitration module the peripheral device priority level from the peripheral device; and
when the CPU priority level and the peripheral device priority level are both set at the highest available priority level outputting by the arbitration module to the memory controller, a new CPU priority level less than the highest available priority level.

14. The method of claim 13, further comprising:
setting the CPU priority level by either said CPU or a device external to said CPU.

15. The method of claim 13, further comprising:
setting the peripheral device priority level by the peripheral device.
